(19) United States
(12) Patent Application Publication
(10) Pub. No.: US 2025/0026668 A1
(43) Pub. Date: Jan. 23, 2025

(54) METHOD AND APPARATUS FOR RECOVERING METHANE FROM A FLOW OF WATER

(71) Applicant: BLUEMETHANE GROUP LTD, London (GB)

(72) Inventors: Néstor Raul Rueda Vallejo, London (GB); Louise Esther Bentata, London (GB)

(21) Appl. No.: 18/705,322

(22) PCT Filed: Oct. 27, 2022
(86) PCT No.: PCT/GB2022/052740

§ 371 Date: Apr. 26, 2024

(30) Foreign Application Priority Data
Oct. 27, 2021 (GB) 2115472.9
Apr. 12, 2022 (GB) 2205426.6

(51) Int. Cl. C02F 1/38; B01D 19/00; C02F 1/20; C02F 1/44; C02F 101/32

(52) U.S. Cl. CPC C02F 1/38; B01D 19/0031; B01D 19/0057; C02F 1/20; C02F 1/44; C02F 2101/32; C02F 2301/024

(57) ABSTRACT

According to the invention there is provided an apparatus (10) for recovering methane from a flow of water containing methane. The apparatus (10) comprises an turbulence generator (11) configured to receive the flow of water. The apparatus (10) also comprises a separator (12) configured to receive an outflow of the turbulence generator (11) and to separate the outflow of the turbulence generator (11) into a first outflow of the separator (12) and a second outflow of the separator (12). The first outflow of the separator (12) is a gas phase comprising a separated fraction of the dissolved methane.

The invention relates to a method for recovering methane from a flow of water containing methane and an apparatus for recovering methane from a flow of water containing methane.

Many sources of water contain dissolved methane that can be recovered. For example, reservoirs, and in particular, hydropower plant reservoirs, may contain dissolved methane. Reservoirs are anthropogenic systems constructed to collect, store, and manage water by blocking the natural water flow of streams and rivers, such as with artificial dams. Once water has been accumulated in the reservoir, water may be withdrawn through one or more turbines for hydropower generation.

The discovery that different sources of water, for example, hydropower plant reservoirs, may constitute important sources of greenhouse gases, including methane, is fairly recent. Studies have shown, for example, that the greenhouse effect of carbon emissions from large hydropower plant reservoirs in Brazil can be significantly higher than that of power plants running on fossil fuels.

This is because, when the area chosen for hosting a reservoir is initially flooded, trees and other plants that grew there begin to rot, and therefore large amounts of carbon that was tied up in the vegetation and soil are released. In a subsequent phase, plant matter and sediments that settled at the bottom of the reservoir decompose in the absence of oxygen, which leads to a build-up of dissolved methane. Seasonal changes in water depth may provide an additional, fresh supply of decaying material, as new plants that get to colonise the banks of the reservoir in the dry season are engulfed when the water level rises.

When methane-rich water passes through the hydropower plant turbines, the sudden drop in hydrostatic pressure causes a large portion of the dissolved methane to be released into the atmosphere. Attempts have been made to identify ways of capturing the methane released into the atmosphere immediately downstream of hydropower plant turbines. By way of example, WO 2008/092216 discloses providing an inflatable hood for collecting gas over the entire turbine discharge area, downstream of the dam. The inflatable hood can be made of a reinforced, impermeable plastic material, and is configured to collect the methane that bubbles up to the surface as a result of depressurization. WO 2008/092216 suggests directing the collected methane to a purifying and de-humidification unit.

Solutions of this type may be beneficial from the viewpoint of mitigating the impact of methane emissions on global warming. However, they do not address the fact that some methane does remain in solution after the water passes through the turbines. In the reservoir, the methane concentration may vary from very low, if not null, at the surface to 100 grams per cubic metre or more at the bottom. After the water passes through the turbines, the residual concentration of methane may be in the range of 1 gram per cubic metre to 10 grams per cubic metre.

Given the volumes of water passing through the turbines of a hydropower plant each day, it is clear there is a significant amount of methane that may still diffuse into the atmosphere further downstream, and so being able to recover such methane would desirably further reduce greenhouse gas emissions. At the same time, recovering the methane that has remained dissolved in water would be desirable as a recovered methane-rich gaseous mixture could be burned to produce electricity, heat buildings, or destroyed to claim carbon offsets, etc.

Processes and apparatuses are known for treating waste water in ways such that methane can be recovered from organic waste matter. For example, JP 2006/088014 describes a process in which a fresh flow of waste water is mixed with a returned flow of sludge, and the resulting mixture is subjected to an aeration treatment before solid-liquid separation is performed. A fraction of the separated sludge collected as a result of the solid-liquid separation step provides a fresh supply for the returned flow of sludge and is therefore recycled back. The remainder of separated sludge collected after the solid-liquid separation step is fed into an anaerobic treatment tank. Methane is generated by the anaerobic digestion of the sludge.

However, solutions of the type described in JP 2006/088014 rely on an anaerobic bio-process to effectively generate methane from solid organic matter suspended in a flow of waste water rather than provide a way of capturing methane that is already present in dissolved form in the liquid phase of the flow of waste water. Further, solutions of this type might be difficult to adapt to the treatment of a flow of water that has a significantly lower content of dissolved or suspended organic matter.

Use of commercially available separation technologies, such as selective membranes or vacuum towers, may be considered. However, systems based on selective membranes or vacuum towers would entail highly energy-intensive processes. Additionally, these technologies might be particularly expensive to scale up to treat the amounts of water involved within the context of some sources of water, such as hydropower plants. The outflow at dam level in a hydropower plant may be of the order of 1 cubic metre per second and up to hundreds of cubic metres per second, and some of the technologies mentioned above may simply not be viable for the treatment of so large a flow of water.

Therefore, it would be desirable to provide a novel method and apparatus for recovering methane from a flow of water containing methane, for example in the form of dissolved methane and/or in methane bubbles. In particular, it would be desirable to provide a method and apparatus for recovering methane from a flow of water containing methane that is less energy-intensive compared with certain commercially available technologies. It would also be desirable to provide a method and apparatus for recovering methane from a flow of water containing methane that can be operated with cost-effective efficiencies under specific conditions.

According to the invention there is provided a method for recovering methane from a flow of water containing methane, the method comprising: passing the flow of water through a turbulence generator; and feeding an outflow of the turbulence generator through a separator, thereby separating the outflow of the turbulence generator into a first outflow of the separator and a second outflow of the separator, wherein the first outflow of the separator is a gas phase comprising a separated fraction of methane.

According to the invention there is also provided an apparatus for recovering methane from a flow of water containing methane, the apparatus comprising: a turbulence generator configured to receive the flow of water; and a separator configured to receive an outflow of the turbulence generator and to separate the outflow of the turbulence generator into a first outflow of the separator and a second outflow of the separator, wherein the first outflow of the separator is a gas phase comprising a separated fraction of methane.

In the following description, any references to features or properties of the method for recovering methane from the flow of water containing methane according to the invention may also apply to the apparatus for recovering methane from the flow of water containing methane according to the invention, unless stated otherwise.

Passing a flow of water containing methane through the turbulence generator increases a level of turbulence in the flow of water. This may promote phase separation of the flow of water to obtain a gas phase comprising a separated fraction of methane, which may be recovered.

Increasing a level of turbulence in the flow of water may reduce the velocity of the flow of water passing through the turbulence generator and subsequently increase a residence time of the outflow of the turbulence generator passing through the separator. Consequently, this may advantageously promote phase separation of the outflow of the turbulence generator passing through the separator to obtain another gas phase comprising a separated fraction of methane which is methane-rich. The outflow of the turbulence generator passing through the separator may be referred to as the flow through the separator.

Accordingly, the method for recovering methane from a flow of water of the invention may be operated effectively and efficiently. The method for recovering methane from a flow of water of the invention may avoid the need for expensive equipment and may not be highly energy-intensive.

Methane may be present in the flow of water in the form of dissolved methane and/or methane bubbles. In other words, the flow of water may contain dissolved methane and/or methane bubbles.

Accordingly, the first outflow of the separator may be a gas phase comprising a separated fraction of the dissolved methane and/or a separated fraction of methane from the methane bubbles.

The flow of water may be from any suitable source of water, such as natural and artificial (such as, for example, anthropogenic) sources of water. Suitable sources of water include, but are not limited to, rice cultivation and other agricultural streams of water; reservoirs such as hydropower plant reservoirs, non-hydropower plant reservoirs and irrigation reservoirs; lakes such as natural lakes and artificial lakes; anaerobic wastewater processes; wastewater treatments; groundwater processing; seas; oceans; ice melts; inland water; wetlands; peatlands; permafrost; undersea clathrates; submarine taliks; river transports; ice complex retreats; submarine permafrost; decaying gas hydrate deposits; landfill leachates; estuaries; mangroves; coal mines; flooded coal mines; tailing dams; gas fields; wells, such as oil wells and gas wells; drilling, fracking or completing processes associated with oil wells or gas wells; and groundwater.

In particular, the flow of water may be an outflow of a hydropower plant. The hydropower plant may be a hydropower dam.

The method may comprise measuring a flow rate of the flow of water.

The flow of water may have a flow rate of at least about 1 cubic metre per second. Preferably, the flow of water may have a flow rate of at least about 2 cubic metres per second. More preferably, the flow of water may have a flow rate of at least about 3 cubic metres per second. Even more preferably, the flow of water may have a flow rate of at least about 5 cubic metres per second. Most preferably, the flow of water may have a flow rate of at least about 10 cubic metres per second. These flow rates may be particularly applicable to an outflow of a hydropower plant.

It will be understood that, in general, the flow of water that is passed through the turbulence generator and fed further to the separator may be only a fraction of a total flow of water from a source of water. For example, where the flow of water is an outflow of a hydropower plant, the outflow of the hydropower plant that is passed through a turbulence generator and fed further to the separator may be only a fraction of a total flow of water downstream of the turbines of the hydropower plant. Operating with a larger flow of water may generally be desirable both in terms of overall amount of recoverable methane and in view of the greater amount of kinetic energy accumulated in the flow of water that can be utilised in the separation step.

The flow rate of the flow of water may be such that the flow of water has sufficient kinetic energy to enable the flow of water to flow through at least the turbulence generator and the separator without the need for a pump. As such, the method for recovering methane from a flow of water of the invention may advantageously be operated with energy-effective and cost effective efficiencies. Operating with one such flow rate of the flow of water is therefore preferable. However, there may be circumstances under which some source of additional hydraulic power may be required.

The method may comprise measuring an amount of methane in the flow of water. For example, the method may comprise measuring an amount of methane in the form of dissolved methane and/or in methane bubbles in the flow of water.

The flow of water may comprise methane in an amount of at least about 0.5 grams per cubic metre. Preferably, the flow of water comprises methane in an amount of at least about 1 gram per cubic metre. More preferably, the flow of water comprises methane in an amount of at least about 2 grams per cubic metre. Even more preferably, the flow of water comprises methane in an amount of at least about 5 grams per cubic metre.

In particularly preferred embodiments, the flow of water may comprise methane in an amount of at least about 7 grams per cubic metre, more preferably at least about 8 grams per cubic metre, even more preferably at least about 9 grams per cubic metre. Most preferably, the flow of water comprises methane in an amount of at least about 10 grams per cubic metre.

The amount of methane in the flow of water described above may be particularly applicable to an outflow of a hydropower plant.

The amount of methane in the flow of water described above may be equal to the sum of the amount of dissolved methane in the flow of water and the amount of methane in methane bubbles in the flow of water.

The amount of methane in the flow of water described above may equally apply to the amount of dissolved methane in the flow of water or the amount of methane in methane bubbles in the flow of water.

The flow of water may flow through the turbulence generator by gravity without the need for a pump. As such, the method for recovering methane from a flow of water of the invention may advantageously be operated with energy-effective and cost effective efficiencies.

The turbulence generator may be a static device with no moving components.

As mentioned above, passing the flow of water through the turbulence generator may thereby separate methane out from the flow of water into a gas phase.

The method may comprise collecting or recovering the gas phase from the turbulence generator.

Recovering the gas phase from the turbulence generator may be by means of a pressure reducing device, such as a vacuum pump.

Recovering the gas phase from the turbulence generator may promote the gas phase to flow in a direction opposite to the direction of flow of the flow of water though the turbulence generator. The flow of water and the flow of the gas phase in the turbulence generator may be such that a counter-current exchange is set up to promote further phase separation of methane from the flow of water into the gas phase. This may enable a greater proportion of methane in the flow of water to be collected at the turbulence generator.

Any collected gas phase may undergo a methane purification process.

The method may comprise circulating a first portion of the first outflow of the separator into the turbulence generator. In this way, the turbulence generator may, in effect, be an aerator. This may reduce the velocity of the flow of water passing through the aerator and may increase a concentration of methane in the outflow of the aerator. Consequently, this may advantageously promote phase separation of the outflow of the aerator passing through the separator to obtain a gas phase comprising a separated fraction of methane which is methane-rich.

Preferably, the first portion of the first outflow of the separator is a portion of the first outflow of the separator that has not undergone any treatment to remove methane. Preferably, the first portion of the first outflow of the separator comprises methane, for example, in the form of dissolved methane and/or in methane bubbles. The first portion of the first outflow of the separator which is circulated into the aerator may comprise a same concentration of methane as the first outflow of the separator.

Circulating the first portion of the first outflow of the separator into the aerator may comprise injecting the first portion of the first outflow of the separator into the flow of water passing through the aerator. This may increase a level of turbulence in the flow of water passing through the aerator. This may also facilitate the creation of bubbles in the flow of water passing through the aerator. An increased level of turbulence and concentration of bubbles in the flow of water passing through the aerator may advantageously increase the concentration of methane in the flow of water passing through the aerator. Subsequently, this may advantageously increase the amount of methane that may be separated out of the outflow of the aerator passing through the separator. Additionally, an increased level of turbulence, along with the increased overall surface area provided by the bubbles, may advantageously enhance mass transfer at the gas-liquid interface in the separator.

The amount of the first portion of the first outflow of the separator that is circulated into the aerator may be selected based on a desired concentration of methane in the flow of water passing through the aerator and subsequently a concentration of methane in the outflow of the aerator. An increased concentration of methane in the flow of water passing through the aerator and an increased concentration of methane in the outflow of the aerator may advantageously increase the amount of methane that may be separated out of the outflow of the aerator passing through the separator.

However, the first portion of the first outflow of the separator that is circulated into the aerator may not be available, for example, for collection. As such, the amount of the first portion of the first outflow of the separator that is circulated into the aerator may vary depending on the stage in the process for recovering methane from the flow of water.

For example, at the beginning of the process for recovering methane from the flow of water, a greater portion of the first outflow of the separator may be circulated into the aerator in order to substantially increase the concentration of methane in the flow of water passing through the aerator. For example, the first portion of the first outflow of the separator, which is circulated into the aerator, may constitute at least about 80 percent by volume of the first outflow of the separator. Preferably, the first portion of the first outflow of the separator, which is circulated into the aerator, constitutes at least about 90 percent by volume of the first outflow of the separator. More preferably, the first portion of the first outflow of the separator, which is circulated into the aerator, constitutes up to 100 percent by volume of the first outflow of the separator.

Subsequently, once a concentration of methane in the first outflow of the separator reaches a threshold value, for example a concentration desirable for collection or processing, a smaller portion of the first outflow of the separator may be circulated into the aerator.

The first portion of the first outflow of the separator, which is circulated into the aerator, may constitute at least about 0.5 percent by volume of the first outflow of the separator. Preferably, the first portion of the first outflow of the separator, which is circulated into the aerator, constitutes at least about 1 percent by volume of the first outflow of the separator. More preferably, the first portion of the first outflow of the separator, which is circulated into the aerator, constitutes at least about 2 percent by volume of the first outflow of the separator. Even more preferably, the first portion of the first outflow of the separator, which is circulated into the aerator, constitutes at least about 3 percent by volume of the first outflow of the separator.

The first portion of the first outflow of the separator, which is circulated into the aerator, may constitute up to about 10 percent by volume of the first outflow of the separator. Preferably, the first portion of the first outflow of the separator, which is circulated into the aerator, constitutes up to about 7 percent by volume of the first outflow of the separator. More preferably, the first portion of the first outflow of the separator, which is circulated into the aerator, constitutes up to about 6 percent by volume of the first outflow of the separator. Even more preferably, the first portion of the first outflow of the separator, which is circulated into the aerator, constitutes up to about 5 percent by volume of the first outflow of the separator.

In some embodiments, the first portion of the first outflow of the separator, which is circulated into the aerator, may constitute from about 1 percent to about 10 percent by volume of the first outflow of the separator, preferably from about 1 percent to about 7 percent by volume of the first outflow of the separator, more preferably from about 1 percent to about 6 percent by volume of the first outflow of the separator, even more preferably from about 1 percent to about 5 percent by volume of the first outflow of the separator. In other embodiments, the first portion of the first outflow of the separator, which is circulated into the aerator, may constitute from about 2 percent to about 20 percent by volume of the first outflow of the separator, preferably from about 2 percent to about 7 percent by volume of the first outflow of the separator, more preferably from about 2 percent to about 6 percent by volume of the first outflow of the separator, even more preferably from about 2 percent to about 5 percent by volume of the first outflow of the separator. In further embodiments, the first portion of the first outflow of the separator, which is circulated into the aerator, may constitute from about 3 percent to about 30 percent by volume of the first outflow of the separator, preferably from about 3 percent to about 7 percent by volume of the first outflow of the separator, more preferably from about 3 percent to about 6 percent by volume of the first outflow of the separator, even more preferably from about 3 percent to about 5 percent by volume of the first outflow of the separator.

The ranges for the proportion of the first outflow of the separator that is circulated into the aerator described above may be particularly applicable where the flow of water is an outflow of a hydropower plant.

The method may comprise feeding a secondary source of methane through the turbulence generator. Suitable secondary sources of methane include but are not limited to wastewater or an outflow of a water treatment reactor. Feeding a secondary source of methane through the turbulence generator may further increase the concentration of methane in the flow of water passing through the turbulence generator.

The method may comprise measuring a flow rate of the outflow of the turbulence generator.

The flow rate of the outflow of the turbulence generator may be selected based on a desired flow rate of the outflow of the turbulence generator passing through the separator. An increased flow rate of the outflow of the turbulence generator may enable the outflow of the turbulence generator to pass through the separator without the need for a pump. An increased residence time of the outflow of the turbulence generator passing through the separator may advantageously result in an increased amount of methane separated out of the outflow of the turbulence generator and into the first outflow of the separator.

The outflow of the turbulence generator may have a flow rate of at least about 1 cubic metre per second. Preferably, the outflow of the turbulence generator has a flow rate of at least about 2 cubic metres per second. More preferably, the outflow of the turbulence generator has a flow rate of at least about 3 cubic metres per second. Even more preferably, the outflow of the turbulence generator has a flow rate of at least about 5 cubic metres per second. Most preferably, the outflow of the turbulence generator has a flow rate of at least about 10 cubic metres per second.

The ranges for the flow rate of the outflow of the turbulence generator described above may be particularly applicable where the flow of water is an outflow of a hydropower plant.

The method may comprise measuring an amount of methane in the outflow of the turbulence generator. For example, the method may comprise measuring an amount of methane in the form of dissolved methane and/or in methane bubbles in the outflow of the turbulence generator.

The method may comprise measuring a flow rate of the first outflow of the separator.

Where the method comprises circulating a first portion of the first outflow of the separator into an aerator, the flow rate of the first outflow of the separator may be such that it facilitates circulation of the first portion of the first outflow of the separator into the aerator.

The first outflow of the separator may have a flow rate of at least about 5×10⁻³ cubic metres per second. Preferably, the first outflow of the separator has a flow rate of at least about 1×10⁻² cubic metres per second. More preferably, the first outflow of the separator has a flow rate of at least about 2×10⁻² cubic metres per second. Even more preferably, the first outflow of the separator has a flow rate of at least about 3×10⁻² cubic metres per second.

The ranges for the flow rate of the first outflow of the separator described above may be particularly applicable where the flow of water is an outflow of a hydropower plant.

The method may comprise measuring an amount of methane in the first outflow of the separator.

The first outflow of the separator may comprise methane in an amount of at least about 0.5 grams per cubic metre. Preferably, the first outflow of the separator comprises methane in an amount of at least about 1 gram per cubic metre. More preferably, the first outflow of the separator comprises methane in an amount of at least about 2 grams per cubic metre. Even more preferably, the first outflow of the separator comprises methane in an amount of at least about 5 grams per cubic metre.

In particularly preferred embodiments, the first outflow of the separator may comprise methane in an amount of at least about 7 grams per cubic metre, more preferably at least about 8 grams per cubic metre, even more preferably at least about 9 grams per cubic metre. Most preferably, the first outflow of the separator comprises methane in an amount of at least about 10 grams per cubic metre.

The first outflow of the separator may comprise methane in an amount of up to about 4 percent by volume.

The ranges for the amount of methane in the first outflow of the separator described above may be particularly applicable where the flow of water is an outflow of a hydropower plant.

The method may comprise collecting the first outflow of the separator. That is, the method may comprise collecting the gas phase from the separator. Collecting the gas phase from the separator may also be referred to as recovering the gas phase from the separator.

Collecting the first outflow of the separator may be by means of a pressure reducing device, such as a vacuum pump.

The collected first outflow of the separator comprises a gaseous mixture that may, even at relatively low methane concentrations, be already suitable for use without requiring additional treatments aiming at purifying the gaseous mixture or at further increasing the methane concentration in the gaseous mixture. Without wishing to be bound by theory, it is understood that the collected first outflow of the separator may find use as fuel in lean and ultra-lean combustion processes that can be sustained at methane concentrations as low as 0.5 grams per cubic metre.

The method may comprise collecting the first outflow of the separator once an amount of methane in the first outflow of the separator reaches a threshold value.

The threshold value for the amount of methane in the first outflow of the separator may be at least about 0.5 grams per cubic metre. Preferably, the threshold value for the amount of methane in the first outflow of the separator is at least about 1 gram per cubic metre. More preferably, the threshold value for the amount of methane in the first outflow of the separator is at least about 2 grams per cubic metre. Even more preferably, the threshold value for the amount of methane in the first outflow of the separator is at least about 5 grams per cubic metre.

In particularly preferred embodiments, the threshold value for the amount of methane in the first outflow of the separator is at least about 7 grams per cubic metre, more preferably at least about 8 grams per cubic metre, even more preferably at least about 9 grams per cubic metre. Most preferably, the threshold value for the amount of methane in the first outflow of the separator is at least about 10 grams per cubic metre.

The threshold values described above may be particularly applicable where the flow of water is an outflow of a hydropower plant.

Where the method comprises circulating a first portion of the first outflow of the separator into an aerator, the method may comprise collecting a second portion of the first outflow of the separator.

The threshold value for the amount of methane in the first outflow of the separator discussed above may also be applicable when collecting a second portion of the first outflow of the separator.

Once the amount of methane in the first outflow of the separator reaches the threshold value, a smaller portion of the first outflow of the separator may be circulated back into the aerator. That is, once the amount of the methane in the first outflow of the separator reaches the threshold value, the first portion of the first outflow of the separator may constitute a smaller fraction of the first outflow of the separator.

The second outflow of the separator is a methane-depleted fraction of the flow of water.

The second outflow of the separator may comprise a liquid phase.

The second outflow of the separator may comprise a solid phase. The solid phase may comprise sediments. The solid phase may be treated to produce additional methane.

The second outflow of the separator may comprise both a liquid phase and a solid phase.

The second outflow of the separator may comprise organic matter, for example solid organic matter.

The method may comprise passing at least a portion of, or the entirety of, the second outflow of the separator into a natural body of water. Suitable natural bodies of water include but are not limited to rivers.

The method may comprise passing at least a portion of, or the entirety of, the second outflow of the separator into a reservoir, for example a reservoir of a hydropower plant, or an irrigation reservoir.

The method may comprise processing at least a portion of, or the entirety of, the second outflow of the separator to produce methane. In particular, where the second outflow of the separator comprises organic matter, for example from sediments that may be present in the flow of water, processing at least a portion of the second outflow of the separator may recover methane from the organic matter.

The method may comprise feeding at least a portion of, or the entirety of, the second outflow of the separator through a water treatment reactor. The water treatment reactor may be an aerobic treatment reactor or an anaerobic treatment reactor, such as an upflow anaerobic sludge blanket reactor (UASB reactor). Feeding at least a portion of the second outflow of the separator through the water treatment reactor may produce methane. The method may comprise collecting methane from the water treatment reactor. The method may comprise passing an outflow of the water treatment reactor into a natural body of water.

The second outflow of the separator may contain a recoverable amount of dissolved methane.

The method may comprise measuring an amount of methane in the second outflow of the separator.

An amount of methane in the second outflow of the separator may be less than the amount of methane in the flow of water.

The second outflow of the separator may comprise methane in an amount of up to about 0.5 grams per cubic metre The second outflow of the separator may comprise methane in an amount of up to about 0.3 grams per cubic metre, preferably up to about 0.2 grams per cubic metre, more preferably up to 0.1 grams per cubic metre. Even more preferably, the second outflow of the separator comprises a negligible amount of methane, for example, up to about 1 milligram per cubic metre.

The ranges for the amount of methane in the second outflow of the separator described above may be particularly applicable where the flow of water is an outflow of a hydropower plant.

The method may comprise passing at least a portion of, or the entirety of, the second outflow of the separator through a selective membrane. Passing at least a portion of the second outflow of the separator through the selective membrane may separate methane from the second outflow of the separator.

The method may also comprise feeding stripping gas into the membrane contactor. This may facilitate separation of methane from the second outflow of the separator passing through the selective membrane.

The method may comprise collecting methane from the selective membrane. The method may comprise passing an outflow of the selective membrane into a natural body of water.

The method may comprise both processing at least a portion of the second outflow of the separator to produce methane and passing at least a portion of the second outflow of the separator through a selective membrane. The method may comprise processing at least a portion of the second outflow of the separator to produce methane prior to passing the at least a portion of the second outflow of the separator through a selective membrane.

The method may comprise both feeding at least a portion of the second outflow of the separator through a water treatment reactor and passing at least a portion of the second outflow of the separator through a selective membrane. For example, the method may comprise feeding at least a portion of the second outflow of the separator through a water treatment reactor and passing at least a portion of an outflow of the water treatment reactor through a selective membrane.

The method may comprise passing at least a portion of, or the entirety of, the second outflow of the separator through a filter.

The method may comprise feeding at least a portion of the second outflow of the separator through a water treatment reactor and passing at least a portion of an outflow of the water treatment reactor through a filter. The method may comprise passing at least a portion of the separator through a filter and passing an outflow of the filter through a selective membrane.

The flow rate of the second outflow of the separator may be selected based on whether at least part of the second outflow of the separator is, for example, passed into a natural body of water, passed into a reservoir, processed to produce methane, passed through a filter, and/or passed through a selective membrane.

The method may comprise measuring a flow rate of the second outflow of the separator.

The second outflow of the separator may have a flow rate of at least about 1 cubic metre per second. Preferably, the second outflow of the separator has a flow rate of at least about 2 cubic metres per second. More preferably, the second outflow of the separator has a flow rate of at least about 3 cubic metres per second. Even more preferably, the second outflow of the separator has a flow rate of at least about 5 cubic metres per second.

The second outflow of the separator may have a flow rate of up to about 50 cubic metres per second.

The ranges for the flow rate of the second outflow of the separator described above may be particularly applicable where the flow of water is an outflow of a hydropower plant.

The invention relates to an apparatus for recovering methane from a flow of water containing methane, the apparatus comprising: a turbulence generator configured to receive the flow of water; and a separator configured to receive an outflow of the turbulence generator and to separate the outflow of the turbulence generator into a first outflow of the separator and a second outflow of the separator, wherein the first outflow of the separator is a gas phase comprising a separated fraction of methane.

The turbulence generator increases a level of turbulence of the flow of water passing therethrough. This may promote phase separation of the flow of water to obtain a gas phase comprising a separated fraction of methane, which may be recovered.

Increasing a level of turbulence in the flow of water may reduce the velocity of the flow of water passing through the turbulence generator and subsequently increase a residence time of the outflow of the turbulence generator passing through the separator. Consequently, this may advantageously promote phase separation of the outflow of the turbulence generator passing through the separator to obtain another gas phase comprising a separated fraction of methane which is methane-rich.

Accordingly, the apparatus of the invention may effectively recover methane from a flow of water.

The apparatus may be configured to carry out the method of the invention.

The apparatus may comprise a sensor configured to measure a flow rate of the flow of water.

The apparatus may comprise a sensor configured to measure an amount of methane in the flow of water, for example, methane in the form of dissolved methane and/or in methane bubbles.

The apparatus may comprise a circulating means for circulating a first portion of the first outflow of the separator into the turbulence generator. This may particularly be the case where the turbulence generator is an aerator. An aerator and a circulating means for circulating a first portion of the first outflow of the separator into the aerator may reduce the velocity of the flow of water passing through the aerator and may increase a concentration of dissolved methane in the flow of water passing through the aerator. This may subsequently increase a concentration of dissolved methane in the outflow of the aerator. This may also subsequently increase a residence time of the outflow of the aerator passing through the separator. Consequently, this may advantageously promote phase separation of the outflow of the aerator passing through the separator to obtain a gas phase comprising a separated fraction of the dissolve methane which is methane-rich.

The circulating means may be configured to circulate a variable amount of the first portion of the first outflow of the separator into the aerator. The circulating means may comprise a valve. This may be advantageous since a desired amount of the first portion of the first outflow of the separator that is circulated into the aerator may vary depending on the stage in the use of the apparatus for recovering methane from the flow of water. For example, during the early stages of use of the apparatus for recovering methane from the flow of water, a greater portion of the first outflow of the separator may be circulated into the aerator in order to increase the concentration of methane in the flow of water passing through the aerator. This may subsequently increase a concentration of methane in the first outflow of the separator. Subsequently, once the concentration of methane in the first outflow of the separator reaches a threshold concentration, for example, for collection, a smaller portion of the first outflow of the separator may be circulated into the aerator.

The apparatus may comprise a sensor configured to measure a flow rate of the outflow of the turbulence generator.

The apparatus may comprise a sensor configured to measure an amount of methane in the outflow of the turbulence generator, for example, methane in the form of dissolved methane and/or in methane bubbles.

The apparatus may comprise a collecting means for collecting a second portion of the first outflow of the separator. For example, the apparatus may comprise a pressure reducing device for collecting a second portion of the first outflow of the separator. The pressure reducing device may be a vacuum pump.

The collecting means may be configured to collect the second portion of the first outflow of the separator once an amount of methane in the first outflow of the separator reaches a threshold value.

The apparatus may comprise a sensor configured to measure an amount of methane in the first outflow of the separator.

The turbulence generator may be a static device that does not comprising any moving components.

The turbulence generator preferably comprises a conduit along which the flow of water flows. The conduit may be a tube. The conduit may be a chute.

The length of the conduit may be selected based on properties of the flow of water. For example, where the flow rate of the flow of water is relatively high, it may be particularly desirable for the conduit to have a larger length. This may be such that the flow rate of the outflow of the turbulence generator is at a desired level to promote phase separation in the separator.

The conduit may have a length of about 1 metre or more, about 2 meters or more, or about 5 metres or more.

The conduit may have a length of about 20 metres or less, about 15 metres or less, or about 12 metres or less.

The conduit may have a length of between about 1 metre and about 20 metres, about 1 metre and about 15 metres, or about 1 metre and about 12 metres. The conduit may have a length of between about 2 metres and about 20 metres, about 2 metres and about 15 metres, or about 2 metres and about 12 metres. The conduit may have a length of between about 5 metres and about 20 metres, about 5 metres and about 15 metres, or about 5 metres and about 12 metres.

An inclination angle of the conduit may be selected based on a desired flow rate of the flow of water passing through the turbulence generator and the flow rate of the outflow of the turbulence generator. The inclination angle of the conduit may also be such that the outflow of the turbulence generator has sufficient kinetic energy to effectively pass through the separator to separate the outflow of the turbulence generator into the first outflow of the separator and a second outflow of the separator without the need for a pump. This may enable the apparatus of the invention to be operated with energy-effective and cost-effective efficiencies. However, there may be some circumstances under which some source of additional hydraulic power may be required.

The conduit may have a non-null inclination angle. As used herein with reference to the invention, the term “inclination angle” is used to refer to an angle between the bottom of the conduit and the horizontal. The bottom of the conduit being a surface along which the flow of water flows. The bottom of the conduit may also be referred to as the base of the conduit.

In other words, an angle between the bottom of the conduit and the horizontal may be greater than zero.

The conduit may have an inclination angle of at least about 1 degree. The conduit may have an inclination angle of at least about 2 degrees. In some embodiments, the conduit may have an inclination angle of at least about 5 degrees, preferably at least about 10 degrees, more preferably at least about 15 degrees.

The conduit may have an inclination angle of up to about 30 degrees, preferably up to about 25 degrees, more preferably up to about 20 degrees.

Preferably, the turbulence generator comprises at least one protrusion. The at least one protrusion may promote turbulence in the flow of water passing along the conduit. The protrusion may be referred to as a deflector.

The at least one protrusion may project from a bottom of the conduit.

The turbulence generator may comprise at least 2 protrusions, at least 4 protrusions, at least 6 protrusions, or at least 10 protrusions.

The turbulence generator may comprise up to 40 protrusions, up to 30 protrusions, or up to 20 protrusions.

The turbulence generator may comprise between 2 and 40 protrusions, between 4 and 40 protrusions, between 6 and 40 protrusions, or between 10 and 40 protrusions. The turbulence generator may comprise between 2 and 30 protrusions, between 4 and 30 protrusions, between 6 and 30 protrusions, or between 10 and 30 protrusions. The turbulence generator may comprise between 2 and 20 protrusions, between 4 and 20 protrusions, between 6 and 20 protrusions, or between 10 and 20 protrusions.

The number of protrusions may be selected based on a desired level of turbulence in the flow of water passing through the turbulence generator and the flow rate of the outflow of the turbulence generator.

The protrusion may be in the form of, for example, a baffle or a step.

The protrusion may be prismatic in shape. The prismatic protrusion may be arranged such that a longitudinal axis thereof extends across the conduit. For example, the prismatic protrusion may be arranged such that the longitudinal axis thereof is perpendicular to the direction of flow along the conduit at the position of the prismatic protrusion. The longitudinal axis of the prismatic protrusion extending between the base faces of the prismatic protrusion.

The protrusion may be three-sided prism (triangular prism) in shape or four-sided prism in shape.

The protrusion has a first side projecting from the base of the conduit and extending across at least a part of the width of the conduit, and a second side projecting from the base of the conduit and extending across at least a part of the width of the conduit. The first side being upstream of the second side.

One or both of the first side and the second side of the projection may be curved. One or both of the first side and the second side of the projection may be flat.

The first side may form an angle with the base of the conduit of about 20 degrees or more, about 40 degrees or more, or about 60 degrees or more.

The first side may form an angle with the base of the conduit of about 160 degrees or less, about 140 degrees or less, or 120 degrees or less.

The first side may form an angle with the base of the conduit of between about 20 degrees and about 160 degrees, or between about 20 degrees and 140 degrees, or between about 20 degrees and 120 degrees. The first side may form an angle with the base of the conduit of between about 40 degrees and about 160 degrees, or between about 40 degrees and 140 degrees, or between about 40 degrees and 120 degrees. The first side may form an angle with the base of the conduit of between about 60 degrees and about 160 degrees, or between about 60 degrees and 140 degrees, or between about 60 degrees and 120 degrees. For example, the first side may be perpendicular to the base of the conduit.

As used herein, the angle formed between the first side of the protrusion and the base of the conduit refers to the angle external to the protrusion and between the first side of the protrusion and the base of the conduit.

The angle formed between the first side and the base of the conduit may be selected based on a desired level of turbulence in the flow of water passing through the turbulence generator.

The first side may be substantially horizontal. The first side may be inclined upwards with respect to horizontal.

The second side may form an angle with the base of the conduit of between about 20 degrees and about 160 degrees, or between about 20 degrees and 140 degrees, or between about 20 degrees and 120 degrees. The second side may form an angle with the base of the conduit of between about 40 degrees and about 160 degrees, or between about 40 degrees and 140 degrees, or between about 40 degrees and 120 degrees. The second side may form an angle with the base of the conduit of between about 60 degrees and about 160 degrees, or between about 60 degrees and 140 degrees, or between about 60 degrees and 120 degrees. For example, the second side may be perpendicular to the base of the conduit.

As used herein, the angle formed between the second side of the protrusion and the base of the conduit refers to the angle external to the protrusion and between the second side of the protrusion and the base of the conduit.

The angle formed between the second side and the base of the conduit may be selected based on a desired level of turbulence in the flow of water passing through the turbulence generator.

The second side may be substantially vertical.

The first side may be substantially perpendicular to the second side of the same protrusion. For example, where the first side of the protrusion is adjacent to the second side of the protrusion, the first side and the second side may form an angle of about 90 degrees. Where the first side of the protrusion is adjacent to the second side of the protrusion, the first side may form an acute angle with the second side of the protrusion. The first side may form an obtuse angle with the second side of the protrusion.

The angle formed between the first side and the second side of the protrusion may be selected based on a desired level of turbulence in the flow of water passing through the turbulence generator.

The protrusion may have a cross-sectional area of about 10% or more of the cross-sectional area of the conduit, about 15% or more of the cross-sectional area of the conduit, or about 20% or more of the cross sectional area of the conduit.

The protrusion may have a cross-sectional area of about 80% or less of the cross-sectional area of the conduit, about 70% or less of the cross-sectional area of the conduit, or about 60% or less of the cross-sectional area of the conduit.

The protrusion may have a cross-sectional area of between about 10% and about 80% of the cross-sectional area of the conduit, between about 10% and about 70% of the cross-sectional area of the conduit, or between about 10% and about 60% of the cross-sectional area of the conduit. The protrusion may have a cross-sectional area of between about 15% and about 80% of the cross-sectional area of the conduit, between about 15% and about 70% of the cross-sectional area of the conduit, or between about 15% and about 60% of the cross-sectional area of the conduit. The protrusion may have a cross-sectional area of between about 20% and about 80% of the cross-sectional area of the conduit, between about 20% and about 70% of the cross-sectional area of the conduit, or between about 20% and about 60% of the cross-sectional area of the conduit.

As used herein, the cross-sectional area of the protrusion refers to the maximum cross-sectional area of the protrusion measured in a plane perpendicular to the base of the conduit.

As used herein, the cross-sectional area of the protrusion as a percentage of the cross-sectional area of the conduit refers to the maximum cross-sectional area of the protrusion measured in a plane perpendicular to the base of the conduit as a percentage of the cross-sectional area of the conduit measured in the same plane as where the protrusion has its maximum cross sectional area.

The cross-sectional area of the protrusion may be selected based on a desired level of turbulence in the flow of water passing through the turbulence generator.

The protrusion may have a height of about 10% or more of the height of the conduit, about 15% or more of the height of the conduit, or about 20% or more of the height of the conduit.

The protrusion may have a height of about 80% or less of the height of the conduit, about 70% or less of the height of the conduit, or about 60% or less of the height of the conduit.

The protrusion may have a height of between about 10% and about 80% of the height of the conduit, between about 10% and about 70% of the height of the conduit, or between about 10% and about 60% of the height of the conduit. The protrusion may have a height of between about 15% and about 80% of the height of the conduit, between about 15% and about 70% of the height of the conduit, or between about 15% and about 60% of the height of the conduit. The protrusion may have a height of between about 20% and about 80% of the height of the conduit, between about 20% and about 70% of the height of the conduit, or between about 20% and about 60% of the height of the conduit.

As used herein, the height of the protrusion refers to the maximum dimension of the protrusion measured in a direction perpendicular to the base of the conduit.

As used herein, the height of the protrusion as a percentage of the height of the conduit refers to the maximum dimension of the protrusion measured in a direction perpendicular to the base of the conduit as a percentage of the height of the conduit measured in the same direction and measured where the protrusion has its maximum cross sectional area.

The height of the protrusion may be selected based on a desired level of turbulence in the flow of water passing through the turbulence generator.

The protrusion may extend at least partially across a width of the conduit. Preferably, the protrusion extends across the entire width of the conduit.

Where the turbulence generator comprises a plurality of protrusions, the plurality of protrusions may be located along the length of the conduit.

Where the turbulence generator comprises a plurality of protrusions, at least two of the protrusions may be spaced apart from each other. Each protrusion may be spaced apart from another protrusion.

Where the turbulence generator comprises a plurality of protrusions, each protrusion may be spaced along the conduit by a distance of at least the height of the previous protrusion.

Where the turbulence generator comprises a plurality of protrusions, at least two of the protrusions may be adjacent to each other such that the first side of a protrusion and a second side of a previous protrusion project from the same point along the base of the conduit. Each protrusion may be adjacent to another protrusion. Where the turbulence generator comprises a plurality of protrusions in the form of steps, the steps may be adjacent to each other such that the first side of a step and a second side of the previous step project from the same point along the base of the conduit. The plurality of steps may form a flight of stairs.

Where the turbulence generator comprises a plurality of steps, the inclination angle of the conduit may refer to an angle between the pseudo-bottom of the conduit and the horizontal. As used herein with reference to the invention, the term “pseudo-bottom” refers to an imaginary plane tangent to the edges of the steps. In a side cross-section of the conduit, the pseudo-bottom is identified by an imaginary line connecting the corners of the steps.

Where the turbulence generator comprises a plurality of protrusions, each protrusion may have substantially the same shape and size.

Where the turbulence generator comprises a plurality of protrusions, the turbulence generator may comprise two protrusions which have one or both of a different shape or size.

The turbulence generator may be an aerator.

The aerator may comprise a chute having a bottom and at least one aerator duct.

Where the apparatus comprises a circulating means, the circulating means may be configured to circulate the first portion of the first outflow of the separator through the at least one duct.

The at least one aerator duct may be configured to transport the first portion of the outflow of the separator to the flow of water passing through the aerator. The at least one aerator duct may transport the first portion of the outflow of the separator to the flow of water passing through the aerator without the need for a pump. The at least one aerator duct may transport the first portion of the outflow of the separator to the flow of water passively through static principles. The pressure within the at least one aerator duct may be such that the first portion of the outflow of the separator may be drawn into the aerator duct without the need for a pump. This may enable the apparatus of the invention to be operated with energy-effective and cost-effective efficiencies.

The at least one aerator duct may be configured to inject the first portion of the first outflow of the separator into the flow of water passing through the aerator. This may increase a level of turbulence in the flow of water passing through the aerator. This may also facilitate the creation of bubbles in the flow of water passing through the aerator. An increased level of turbulence and concentration of bubbles in the flow of water passing through the aerator may advantageously increase the concentration of methane in the flow of water passing through the aerator. Subsequently, this may advantageously increase the amount of methane that may be separated out of the outflow of the aerator passing through the separator.

The at least one aerator duct may be configured to transport a gas, such as an inert gas to the flow of water passing through the aerator. For example, the at least one aerator duct may be configured to transport air to the flow of water passing through the aerator. The at least one aerator duct may be configured to inject air into the flow of water passing through the aerator. This may increase a level of turbulence in the flow of water passing through the aerator. This may also facilitate the creation of bubbles in the flow of water passing through the aerator.

During use of the apparatus, the flow of water flows through the chute of the aerator.

The at least one aerator duct may comprise an outlet at the bottom of the chute of the aerator. This may advantageously promote aeration of the flow of water passing through the aerator.

The inclination angle of the conduit of the turbulence generator described above may be particularly applicable to the inclination angle of the chute of the aerator. The inclination angle of the chute may be such that the flow of water passing through the aerator has a flow rate that facilitates an increase in the concentration of methane in the flow of water passing through the aerator.

The bottom of the chute may comprise a plurality of steps.

The apparatus may comprise a collecting means for collecting a gas phase from the turbulence generator. The gas phase comprising methane. For example, the apparatus may comprise a pressure reducing device for collecting a gas phase from the turbulence generator. The pressure reducing device may be a vacuum pump.

The collecting means may be arranged towards an upstream end of the turbulence generator. The flow of water enters the turbulence generator at the upstream end of the turbulence generator and the outflow of the turbulence generator exits the turbulence generator at the downstream end of the turbulence generator. Such an arrangement of the collecting means may mean that the gas phase flows in a direction opposite to the direction of the flow of water in the turbulence generator. A counter-current exchange may be set up to further promote the separation of methane from the flow of water to the flow of the gas phase.

The separator may be referred to as a liquid-gas separator.

The separator may comprise an upper wall and a side wall. The upper wall and the side wall may define a chamber of the separator.

When passing through the separator, residual methane in the outflow of the turbulence generator is separated into a gas phase. The flow through the separator may be a methane-containing aqueous phase.

Increasing the residence time of the methane-containing aqueous phase in the separator may promote phase separation of methane out of the aqueous phase and into the gas phase.

A residence time of the methane-containing aqueous phase in the separator will generally be inversely proportional to a flow rate of the outflow of the turbulence generator. All other variables being equal, the larger the volume of methane-containing aqueous phase held within the separator, the greater the residence time.

An internal volume of the separator may be at least about 50 cubic metres. Preferably, an internal volume of the separator may be at least about 100 cubic metres. More preferably, an internal volume of the separator may be at least about 150 cubic metres.

In general, an internal volume of the separator may be up to about 500 cubic metres. Preferably, an internal volume of the separator may be less than or equal to about 400 cubic metres. More preferably, an internal volume of the separator may be at least about 300 cubic metres.

In some embodiments, an internal volume of the separator may be from about 50 cubic metres to about 500 cubic metres, preferably from about 50 cubic metres to about 400 cubic metres, more preferably from about 50 cubic metres to about 300 cubic metres.

In some embodiments, an internal volume of the separator may be from about 100 cubic metres to about 500 cubic metres, preferably from about 100 cubic metres to about 400 cubic metres, more preferably from about 100 cubic metres to about 300 cubic metres.

In some embodiments, an internal volume of the separator may be from about 150 cubic metres to about 500 cubic metres, preferably from about 150 cubic metres to about 400 cubic metres, more preferably from about 150 cubic metres to about 300 cubic metres.

Separators defining an internal volume within the ranges described above may advantageously process an outflow of the turbulence generator having a flow rate from about 1 cubic metre per second to about 50 cubic metres per second and ensure a residence time that may favour a satisfactory methane separation relying primarily on passive and static principles of operations.

Separators defining an internal volume within the ranges described above may be particularly advantageous where the flow of water is an outflow of a hydropower plant.

The separator may comprise an inlet configured to receive the outflow of the turbulence generator. The inlet may be positioned along the side wall of the separator.

Preferably, the separator comprises at least one baffle for deflecting the flow of the outflow of the turbulence generator through the separator. In particular, the at least one baffle may be configured to deflect the outflow of the turbulence generator to flow through the separator along a predetermined path. For example, the at least one baffle may be configured to deflect the outflow of the turbulence generator to flow through the separator along a spiral or along concentrical circles, etc. Preferably, the at least one baffle promotes swirling of the flow through the separator.

As such, the presence of at least one baffle may increase the residence time of the outflow of the turbulence generator passing through the separator. This may increase the effectiveness of the separator at separating the outflow of the turbulence generator into the first outflow of the separator and the second outflow of the separator, wherein the first outflow of the separator is the gas phase comprising the separated fraction of the dissolved methane.

The at least one baffle may comprise a first baffle projecting from the side wall of the separator. The first baffle may deflect the flow of the outflow of the turbulence generator through the separator upwards.

The first baffle may project vertically from the side wall of the separator. This may effectively increase an amount of turbulence in the outflow of the turbulence generator passing through the separator, which may promote separation of the outflow of the turbulence generator passing through the separator into the first outflow of the separator and the second outflow of the separator

The first baffle may be annular. The first baffle may share a same vertical axis with the separator.

The at least one baffle may comprise a second baffle depending from the upper wall of the separator.

The second baffle may project vertically from the upper wall of the separator. This may effectively increase an amount of turbulence in the outflow of the turbulence generator passing through the separator, which may promote separation of the outflow of the turbulence generator passing through the separator into the first outflow of the separator and the second outflow of the separator

The second baffle may be annular. The second baffle may share a same vertical axis with the separator.

Where the at least one baffle comprises the first baffle and the second baffle, the first baffle and the second baffle may be spaced apart in the radial direction. The first baffle may be positioned radially inwards from the second baffle. The second baffle may be positioned radially inwards from the first baffle.

The first baffle and the second baffle may vertically overlap. This may increase a level of turbulence in the outflow of the turbulence generator passing through the separator. For example, the first baffle and the second baffle may vertically overlap, but are spaced apart in the radial direction.

The separator may comprise a hydrocyclone. The separator may be a hydrocyclone. A hydrocyclone may be effective at phase separation of the outflow of the turbulence generator passing through the separator to obtain the gas phase comprising the separated fraction of the dissolve methane. A hydrocyclone may not require a pump to effectively phase separate the outflow of the turbulence generator passing through the separator. As such, a hydrocyclone may be an energy-effective and cost-effective separator. However, there may be some circumstances under which some source of additional hydraulic power may be required.

Where a hydrocyclone is used as the separator, it is understood that the velocity of outflow of the turbulence generator at the inlet of the hydrocyclone will have an impact on the centrifugal force field within the hydrocyclone and, as a consequence, on the performance and separation efficiency of the hydrocyclone. If the inlet velocity is too small, it may not be possible to establish a sufficient centrifugal force field required for gas-liquid separation. On the other hand, too high an inlet velocity may undesirably reduce the residence time in the hydrocyclone, which may in turn hinder the separation of methane from the aqueous phase. Therefore, a flow rate of the outflow of the turbulence generator also needs to be taken into account when designing the separator, as the dimension thereof will also impact the residence time.

The discussion above of the internal volume and the at least one baffle of the separator may be particularly applicable to a hydrocyclone.

The apparatus may comprise a pressure reducing device for collecting at least a portion of the first outflow of the separator. The pressure reducing device may be a vacuum pump.

The apparatus may comprise a processing unit for producing methane. The processing unit may be configured to receive at least a portion of, or the entirety of, the second outflow of the separator. The processing unit may be a water treatment reactor. The water treatment reactor may be an aerobic treatment reactor or an anaerobic treatment reactor, such as an upflow anaerobic sludge blanket reactor (UASB reactor).

The apparatus may comprise a sensor configured to measure an amount of methane in the second outflow of the separator.

The apparatus may comprise a selective membrane configured to receive at least a portion of, or the entirety of, the second outflow of the separator.

The selective membrane may be configured to receive stripping gas. That is, the selective membrane may be configured to receive both the second outflow of the separator and stripping gas. The stripping gas may comprise at least one of methane and air

The apparatus may comprise a membrane contactor comprising the selective membrane.

Where the apparatus comprises both a processing unit and a selective membrane, the processing unit may be upstream from the selective membrane. The processing unit may be downstream from the selective membrane.

The apparatus may comprise a filter.

Where the apparatus comprises a filter and a selective membrane, the filter may be upstream from the selective membrane. The selective membrane may be configured to receive an outflow of the filter.

Where the apparatus comprises a processing unit and a filter, the filter may be downstream from the processing unit. The filter may be configured to receive at least a portion of an outflow of the processing unit.

As used herein with reference to the invention, the terms “upstream” and “downstream” describe relative positions of elements, or portions of elements, of the apparatus in relation to the direction in which the flow of water is transported through the apparatus during use.

The apparatus may comprise a sensor configured to measure a flow rate of the second outflow of the separator.

The invention will be further described, by way of example only, with reference to the accompanying drawings in which:

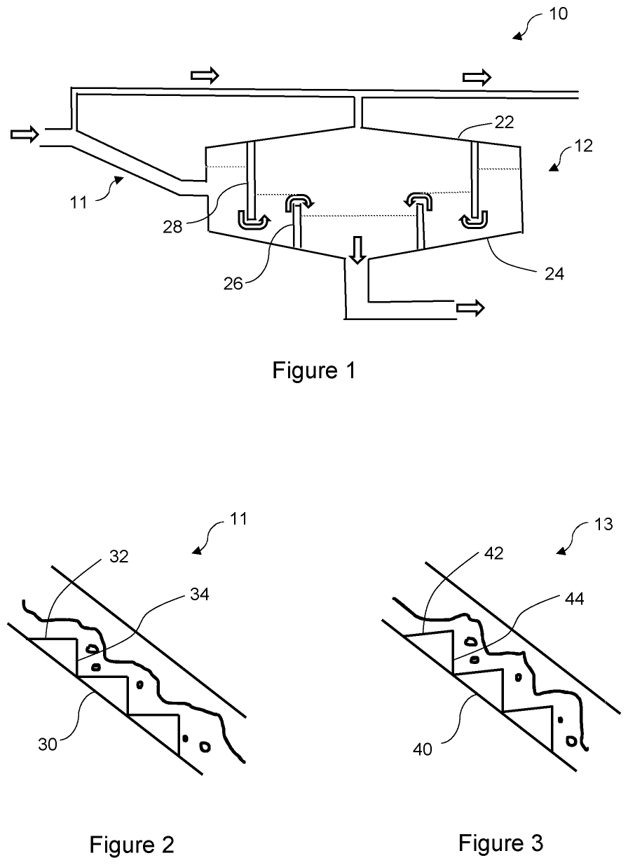

FIG. 1 shows a schematic side sectional view of an apparatus according to a first embodiment of the invention;

FIG. 2 shows a schematic side sectional view of a part of a turbulence generator of the apparatus shown in FIG. 1;

FIG. 3 shows a schematic side sectional view of a part of a turbulence generator of an apparatus according to a second embodiment of the invention;

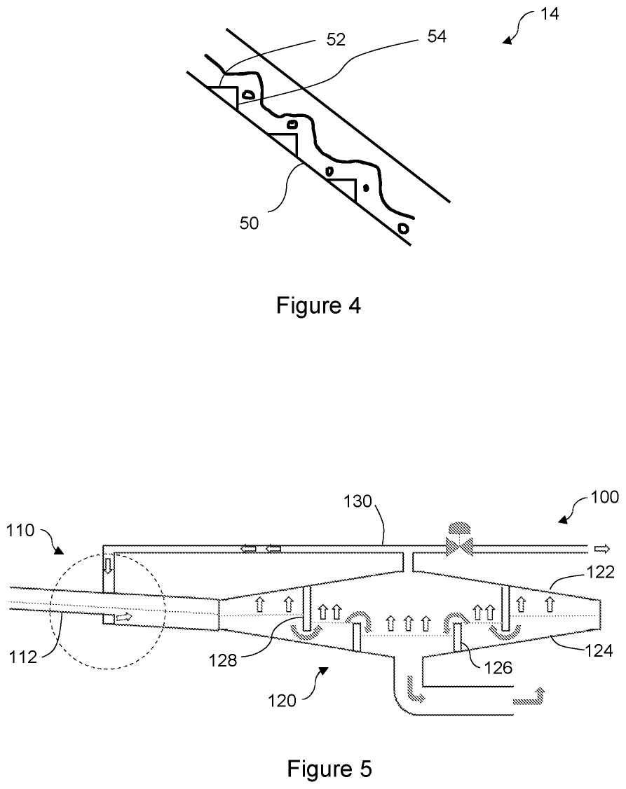

FIG. 4 shows a schematic side sectional view of a part of a turbulence generator of an apparatus according to a third embodiment of the invention;

FIG. 5 shows a schematic side sectional view of an apparatus according to a fourth embodiment of the invention;

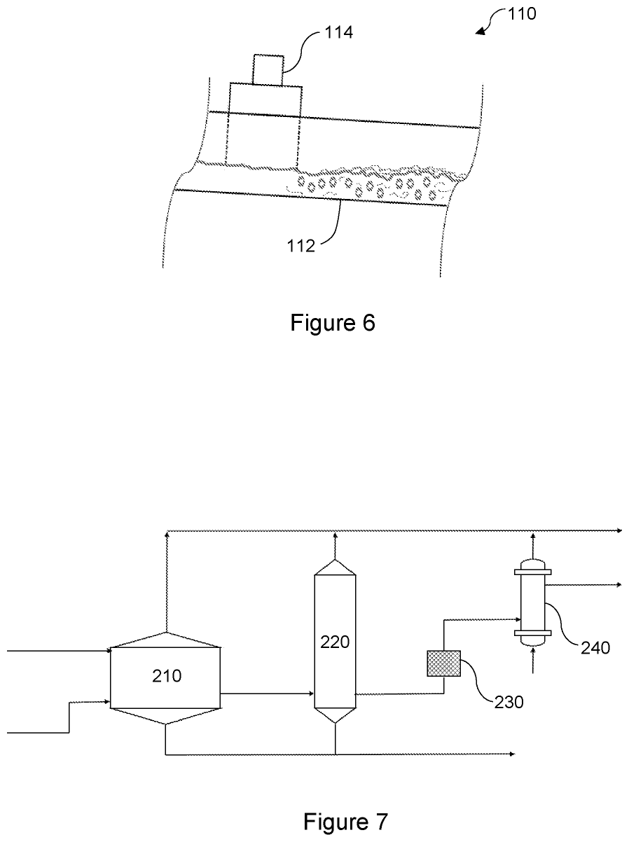

FIG. 6 shows a schematic side sectional view of a part of the aerator of the apparatus shown in FIG. 5; and

FIG. 4 illustrates the method of the invention.

FIG. 1 shows an apparatus 10 for recovering methane from a flow a water, wherein the flow of water comprises dissolved methane and methane bubbles. The flow of water may be, for example, an outflow of a hydropower plant. The apparatus 10 comprises a turbulence generator 11 configured to receive the flow of water. The apparatus 10 also comprises a separator 12 configured to receive an outflow of the turbulence generator 11 and to separate the outflow of the turbulence generator 11 into a fist outflow of the separator 12 and a second outflow of the separator 12. The first outflow of the separator 12 is a gas phase comprising methane.

The turbulence generator 11 comprises a conduit inclined with respect to horizontal. The turbulence generator 11 is a static turbulence generator and does not comprise any moving parts. The flow of water is able to pass along the conduit by gravity.

The turbulence generator 11 comprises a plurality of protrusions (not shown) to promote turbulence in the flow of water.

The separator 12 comprises an upper wall 22 and a side wall 24. The separator 12 also comprises an inlet configured to receive the outflow of the turbulence generator 11.

The separator 12 comprises a first baffle 26 projecting vertically from the side wall 24 of the separator 12. The first baffle 26 is annular in shape.

The separator 12 also comprises a second baffle 28 projecting vertically from the upper wall 22 of the separator 12. The second baffle 128 is annular in shape.

The first baffle 26 and the second baffle 28 are spaced apart in the radial direction, wherein the first baffle 26 is positioned radially inwards from the second baffle 28. Both the first baffle 26 and the second baffle 28 share a same vertical axis with the separator 12. The first baffle 26 and the second baffle 28 vertically overlap.

The apparatus 10 further comprises a collecting means comprising a vacuum pump to recover both the gas phase comprising methane from the turbulence generator 11 and the gas phase comprising methane from the separator 12. The collecting means is arranged so that the gas phase from the turbulence generator 11 is collected towards the upstream end of the turbulence generator 11.

FIG. 2 shows a schematic side-sectional view of a part of the turbulence generator 11 shown in FIG. 1. The turbulence generator 11 comprises a plurality of projections extending from a bottom 30 of the conduit of the turbulence generator 11. The protrusions extend across the entire width of the conduit. The protrusions have substantially the same shape and size as one another.

Each protrusion is a triangular prism and has a first side 32 projecting from the base 30 of the conduit and a second side 34 projecting from the base 30 of the conduit. The second side 34 being downstream of the first side 32. The first side 32 is substantially horizontal and the second side 34 is substantially vertical. As such, the first side 32 of each protrusion is substantially perpendicular to the second side 34 of the same protrusion.

Each protrusion is adjacent to another protrusion, such that at least the first side 32 of a protrusion projects from the same point along the base 30 of the conduit as a second side 34 of a previous protrusion, or the second side 34 of the protrusion projects from the same point along the base 30 of the conduit as a first side 32 of a subsequent protrusion.

The protrusions of the turbulence generator 11 are therefore in the form of continuous steps.

Three protrusions are shown in FIG. 2, however, the turbulence generator 11 may comprise a different number of protrusions.

FIG. 3 shows a schematic side-sectional view of a part of a turbulence generator 13 for an apparatus in accordance with a second embodiment of the invention. The apparatus in accordance with the second embodiment of the invention is similar to the apparatus in accordance with the first embodiment of the invention shown in FIG. 1; the difference being the turbulence generator.

The turbulence generator 13 shown in FIG. 3 is similar to the turbulence generator 11 shown in FIG. 2. The turbulence generator 13 differs from the turbulence generator 11 shown in FIG. 2 in that the first side 42 of each projection is inclined upwards with respect to horizontal. The first side 42 and the second side 44 of each projection form an acute angle therebetween.

FIG. 4 shows a schematic side-sectional view of a part of a turbulence generator 14 for an apparatus in accordance with a third embodiment of the invention. The apparatus in accordance with the third embodiment of the invention is similar to the apparatus in accordance with the first embodiment of the invention shown in FIG. 1; the difference being the turbulence generator.

The turbulence generator 14 shown in FIG. 4 is similar to the turbulence generator 11 shown in FIG. 2. The turbulence generator 14 differs from the turbulence generator 11 shown in FIG. 2 in that each of the protrusions are spaced apart from one another.

FIG. 5 shows an apparatus 100 for recovering methane from a flow of water, wherein the flow of water comprises dissolved methane. The flow of water may be, for example, an outflow of a hydropower plant. The apparatus 100 comprises an aerator 110 configured to receive the flow of water. The apparatus 100 also comprises a separator 120 configured to receive an outflow of the aerator 110 and to separate the outflow of the aerator 110 into a first outflow of the separator 120 and a second outflow of the separator 120. The first outflow of the separator is a gas phase comprising dissolved methane. The apparatus 100 also comprises a circulating means 130 for circulating a first portion of the first outflow of the separator 120 into the aerator 110.

FIG. 6 shows a part of the aerator 110 of the apparatus 100 circled in FIG. 5. The aerator 110 comprises a chute 112 having a bottom. During use of the apparatus 100, the flow of water flows through the chute 112 of the aerator.

The aerator 110 also comprises at least one aerator duct 114. The aerator duct 114 comprises an outlet at the bottom of the chute 112. The aerator 114 is configured to inject the first portion of the first outflow of the separator 120 into the flow of water passing through the aerator 110.

The separator 120 is a hydrocyclone. The hydrocyclone 120 comprises an upper wall 122 and a side wall 124. The hydrocyclone 120 also comprises an inlet configured to receive the outflow of the aerator 110.

The hydrocyclone 120 comprises a first baffle 126 projecting vertically from the side wall 124 of the hydrocyclone 120. The first baffle 126 is annular in shape.

The hydrocyclone 120 also comprises a second baffle 128 projecting vertically from the upper wall 122 of the hydrocyclone 120. The second baffle 128 is annular in shape.

The first baffle 126 and the second baffle 128 are spaced apart in the radial direction, wherein the first baffle 126 is positioned radially inwards from the second baffle 128. Both the first baffle 126 and the second baffle 128 share a same vertical axis with the hydrocyclone 120. The first baffle 126 and the second baffle 128 vertically overlap.

The circulating means 130 comprises a valve 132 for controlling the amount of the first portion of the first outflow of the separator 120 that is circulated into the aerator 110.

FIG. 7 illustrates a method for recovering methane from a flow of water, wherein the flow of water comprises dissolved methane. The flow of water may be, for example, an outflow of a hydropower plant. The method comprises passing the flow of water through an assembly 210 comprising the aerator 110, the separator 120 and the circulating means 130 shown in FIG. 1. Passing the flow of water through the assembly 210 separates the flow of water into a first outflow of the separator 120 and a second outflow of the separator 120. The first outflow is a gas phase comprising a separated fraction of the dissolved methane. Passing the flow of water through the assembly 210 includes circulating a first portion of the first outflow of the separator into the aerator through the circulating means 130.

The method also comprises feeding a secondary source of methane through the assembly 210. In particular, the method comprises feeding the secondary source of methane through the aerator 110 of the assembly 210.

The method further comprises collecting a second portion of the first outflow of the separator. The method also comprises passing at least a portion of the second outflow of the separator into a river.

The method further comprises feeding at least a portion of the second outflow of the separator through an upflow anaerobic sludge blanket reactor (UASB reactor) 220. Feeding at least a portion of the second outflow of the separator through the UASB reactor 220 produces methane. The method also comprises collecting methane from the UASB reactor 220. The method also comprises passing at least a portion of an outflow of the UASB reactor 220 into the river.

The method further comprises passing at least a portion of the outflow of the UASB reactor 220 through a filter 230.

The method also comprises passing an outflow of the filter 230 through a membrane contactor 240 comprising a selective membrane whereby passing the outflow of the filter through the membrane contactor 240 separates methane from the outflow of the filter passing through the membrane contactor 240. The method also comprises feeding stripping gas into the membrane contactor 240. The method also comprises collecting methane from the membrane contactor 240. The method also comprises passing the outflow of the membrane contactor 240 into the river.

The specific embodiments and examples described above illustrate but do not limit the invention. It is to be understood that other embodiments of the invention may be made and the specific embodiments and examples described herein are not exhaustive.

1. A method for recovering methane from a flow of water containing methane, the method comprising:
passing the flow of water through a turbulence generator; and
feeding an outflow of the turbulence generator through a separator, thereby separating the outflow of the turbulence generator into a first outflow of the separator and a second outflow of the separator,
wherein the first outflow of the separator is a gas phase comprising a separated fraction of methane.

2. A method according to claim 1 wherein passing the flow of water through the turbulence generator thereby separates methane out of the flow of water and into a gas phase, and the method further comprises collecting the gas phase from the turbulence generator.

3. A method according to claim 1 wherein the flow of water has a flow rate of at least 1 cubic metre per second.

4. A method according to claim 1 wherein the flow of water comprises methane in an amount of at least about 0.5 grams per cubic metre.

5. A method according to claim 1, wherein the turbulence generator is an aerator, and the method comprises circulating a first portion of the first outflow of the separator into the aerator.

6. A method according to claim 5 wherein circulating the first portion of the first outflow of the separator into the aerator comprises injecting the first portion of the first outflow of the separator into the flow of water passing through the aerator.

7. A method according to claim 1 wherein the first portion of the first outflow of the separator constitutes at least about 0.5 percent by volume of the first outflow of the separator.

8. A method according to claim 1 wherein the first portion of the first outflow of the separator constitutes from about 1 percent to about 10 percent by volume of the first outflow of the separator.

9. A method according to claim 1 further comprising feeding a secondary source of methane through the turbulence generator.

10. A method according to claim 1 wherein the outflow of the turbulence generator has a flow rate of at least about 1 cubic metre per second.

11. A method according to claim 1 wherein the first outflow of the separator comprises methane in an amount of at least about 0.5 grams per cubic metre.

12. A method according to claim 1 further comprising feeding at least part of the second outflow of the separator through a water treatment reactor.

13. A method according to claim 1 further comprising passing at least part of the second outflow of the separator through a selective membrane.

14. A method according to claim 1 wherein the second outflow of the separator has a flow rate of at least about 1 cubic metre per second.

15. An apparatus for recovering methane from a flow of water containing methane, the apparatus comprising:
a turbulence generator configured to receive the flow of water: and
a separator configured to receive an outflow of the turbulence generator and to separate the outflow of the turbulence generator into a first outflow of the separator and a second outflow of the separator,
wherein the first outflow of the separator is a gas phase comprising a separated fraction of methane.

16. An apparatus according to claim 15 wherein the turbulence generator comprises a conduit and at least one protrusion projecting from the bottom of the conduit.

17. An apparatus according to claim 16 wherein the turbulence generator is configured to separate methane from the flow of water and into a gas phase, and the apparatus further comprises a collecting means for collecting the gas phase from the turbulence generator.

18. An apparatus according to claim 15 wherein the turbulence generator is an aerator and the apparatus further comprises a circulating means for circulating a first portion of the first outflow of the separator into the aerator.

19. An apparatus according to claim 18 wherein the circulating means is configured to circulate a variable amount of the first portion of the first outflow of the separator into the aerator.

20. An apparatus according to claim 18 wherein the aerator comprises a chute having a bottom and at least one aerator duct.

21. An apparatus according to claim 20 wherein the circulating means is configured to circulate the first portion of the first outflow of the separator through the at least one aerator duct.

22. An apparatus according to claim 20 wherein the at least one aerator duct comprises an outlet at the bottom of the chute.

23. An apparatus according to claim 15 wherein the conduit of the turbulence generator has an inclination angle of at least about 1 degree.

24. An apparatus according to claim 15 further comprising a sensor configured to detect an amount of methane in the first outflow of the separator.

25. An apparatus according to claim 15 wherein the separator comprises at least one baffle for deflecting the flow of the outflow of the turbulence generator through the separator.

26. An apparatus according to claim 25 wherein the separator comprises an upper wall and a side wall.

27. An apparatus according to claim 26 wherein the at least one baffle comprises a first baffle projecting from the side wall of the separator.

28. An apparatus according to claim 26 wherein the at least one baffle comprises a second baffle depending from the upper wall of the separator.

29. An apparatus according to claim 15 further comprising a water treatment reactor configured to receive at least a portion of the second outflow of the separator.

30. An apparatus according to claim 15 further comprising a selective membrane configured to receive at least a portion of the second outflow of the separator.
